(19) United States
(12) Patent Application Publication
(10) Pub. No.: US 2010/0304873 A1
(43) Pub. Date: Dec. 2, 2010

(54) Bowling Ball and Football Game Controller

(76) Inventors: Lipa Markowitz, Brooklyn, NY (US); Tang Chun Kit, Kowloon (HK)

Correspondence Address: LEVISOHN, BERGER , LLP, 11 BROADWAY , Suite 615, NEW YORK, NY, 10004, US

(21) Appl. No.: 12/790,365

(22) Filed: May 28, 2010

Related U.S. Application Data
(60) Provisional application No. 61/181,912, filed on May 28, 2009.

(51) Int. Cl. A63F 13/02

(52) U.S. Cl. 463/47

(57) ABSTRACT

A ball-shaped housing for encapsulating a game controller. The game controller is held in a compartment within the hollow of a ball. A user accesses control buttons on the game controller by way of buttons on the housing that are mechanically linked to contact ends that are in close proximity to the game controller buttons. When a user presses the buttons on the housing, its mechanical linkages transfer motion to the contact ends, which press respective buttons on the game controller. The invention allows a player to approximate real game conditions and allows for a realistic gaming experience

### RELATED APPLICATIONS

This application claims the benefit of U.S. Provisional Patent Application Ser. No. 61/181,912 filed May 28, 2009—the contents of which are incorporated by reference herein.

### FIELD OF THE INVENTION

The present invention relates to the field of video game accessories, more specifically to a ball-shaped holder for a game controller.

### BACKGROUND OF THE INVENTION

For many years, video games have been a popular form of entertainment for players of all ages and skill levels. Since the earliest games have first been introduced to the public, there has been a continuous effort on the part of game developers to produce games having a realistic feel. In this regard, the NINTENDO WII presents a vast improvement to the state of the art.

WII games are played by means of a WII controller. The WII controller has many buttons for a user to press to control various aspects of the game displayed on a screen, but it also uses accelerometer and optical sensor technology to sense the motion imparted by a player to accordingly manipulate images displayed on a game display screen. Players of WII games use the WII controller to simulate the various motions associated with all types of games and sports such as, for example, bowling, golf, baseball, basketball, golf, tennis, boxing and car racing.

In order to provide players with a more realistic game experience, developers have produced various sports equipment replicas that house the WII controller. For example, a mock tennis racquet or golf club is provided with a compartment for receiving a WIT controller. In this manner, players of WII tennis or golf actually swing a tennis racquet or a golf club when playing the respective WII games. This enhances the overall game experience.

There has been some difficulty, however, creating a similar realistic experience for players of WII Bowling and WII Football—as there is no equipment held by players of these games other than the ball itself. Therefore, in order to effectively simulate a bowling experience, an actual life-sized ball is needed.

### SUMMARY OF THE INVENTION

The current invention is a ball that encloses a game controller therewithin. The ball is designed to replicate a real ball and it is handled as would a normal ball during play. As a result, players of WII Bowling and Football are better able to approximate real playing conditions.

The inventive ball is comprised of two semi-spheres that couple together to form a unitary ball. Inside of the ball there is a compartment for holding a game controller. The compartment is accessible when the ball sections are separated. After inserting the controller into the compartment, the ball is fastened closed and ready for play.

Buttons are provided on the outside surface of the ball, which have spring-biased rods or other mechanical linkages extending therefrom into the center of the ball. Each of the rods terminates in close proximity to a corresponding button on a game controller. Thus, when a button on the outside of the ball is pressed—a corresponding button on the controller is simultaneously pressed. This allows a user to have full functional access to the controller—even while it is encapsulated within a ball.

### BRIEF DESCRIPTION OF THE DRAWINGS

FIG. 1 shows a front, perspective view of a bowling ball according to an embodiment of the invention.

FIG. 2 shows a rear, perspective view of the bowling ball of FIG. 1

FIG. 3 shows a top, exploded view of a bowling ball according to an embodiment of the invention.

FIG. 4 shows a bottom, exploded view of a bowling ball according to an embodiment of the invention.

FIG. 5 shows a side, cross-sectional view of a bowling ball according to an embodiment of the invention with a game controller enclosed therein.

FIG. 6 shows a schematic view of an operation of a preferred embodiment of the present invention.

FIG. 7 shows a schematic view of an implementation of a preferred embodiment of the present invention fitted with wired control.

FIG. 8 shows a schematic view of an implementation of a preferred embodiment of the present invention fitted with wireless control.

FIG. 9 shows a schematic view of a plurality of finger hole inserts according to an embodiment of the invention.

FIG. 10 shows a schematic view of a player inserting an insert according to an embodiment of the invention.

FIG. 11 shows a rear, perspective view of a bowling ball having inserts seated in its finger holes according to an embodiment of the invention.

### DETAILED DESCRIPTION OF THE INVENTION

The following is a detailed description of the preferred embodiments of the invention, reference being made to the drawings in which the same reference numerals identify the same elements of structure in each of the several figures. It should be noted that these drawings are merely exemplary in nature and in no way serve to limit the scope of the invention, which is defined by the claims appearing herein below.

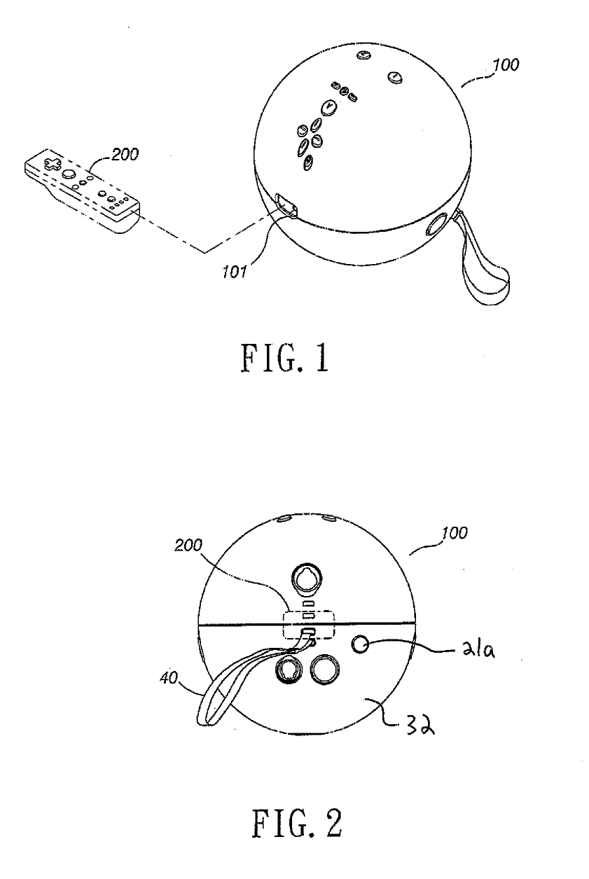

FIG. 1 shows a front view of a ball that is sized and shaped to resemble a real bowling ball. A compartment inside of the ball holds a WII remote. As part of the functionality of the WII remote, there is a sensor that communicates wirelessly with a sensor bar on the WII game console. In order to allow transmission of wireless signals between the WII remote to the sensor bar while the remote is contained within the ball, an opening 101 is provided allowing visual access to the WII remote sensor.

FIG. 2 shows a rear view of the bowling ball 100 (“rear” herein refers to the side of the ball having finger holes, whereas “front” refers to the area diametrically opposed to the finger holes) As shown, three finger holes are provided for a user to grasp the ball Finger holes are positioned substantially similarly to finger holes in a standard bowling ball—in a generally triangular configuration, where two holes are positioned opposite of a single hole. The two holes are for receiving a middle finger and ring finger, respectively, and the single hole is for receiving a thumb.

It should be noted that unlike with real-life bowling, the ball 100 of the current invention is not actually released from a player's grasp. A player only goes through the motion of throwing the ball—without actually releasing it. In order to ensure that the ball does not escape from a player's grip during play, a wrist strap 40 is provided for tethering the ball to a player's wrist. FIG. 6 shows a bowling ball 100 securely tethered to a player's wrist and being “tossed” in accordance with the method of the invention.

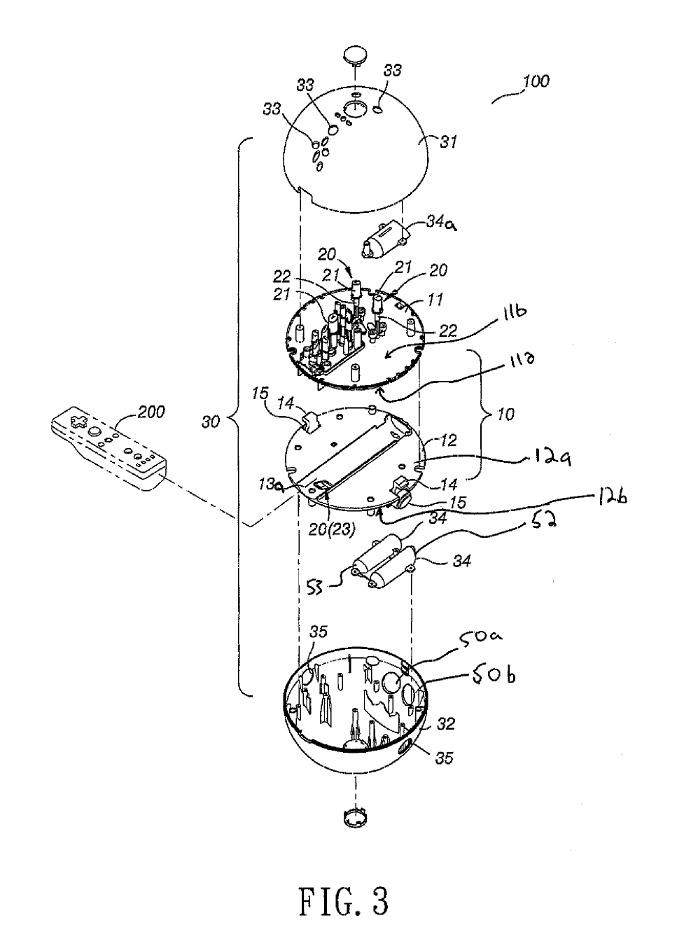

FIG. 3 shows an exploded view of a bowling ball. As shown, the bowling ball housing and mechanical parts 30 consist of the following principal elements: a first, roughly semi-spherical housing 31 and a second, roughly semi-spherical housing 32; a first equatorial plate 11 and a second equatorial plate 12; and a plurality of rod assemblies 20 extending from the equatorial plate 11, through holes 33 formed in spherical housing member 31.

It will be understood that the manner of execution of mechanical linkage from buttons on the surface of the ball 100 to the buttons on the controller comprises substantially conventional techniques, which may be implemented in any of various methods known to those of ordinary skill in the art—which are not novel in itself. Moreover, instead of linkages being mechanical, such linkage could be electronic. For example, hard-wired or wireless transmission of current could power mechanical movement of cams, pistons or the like to contact and press buttons on the game controller stored within the compartment in the cavity of the ball.

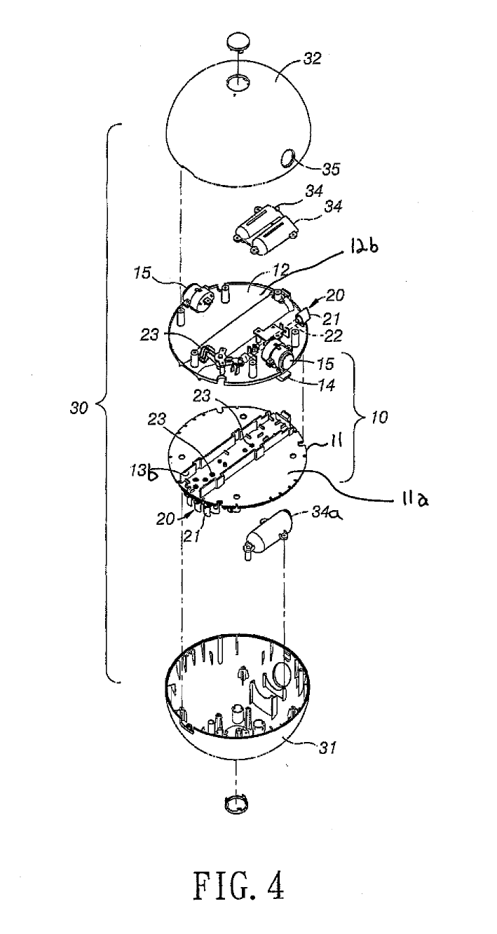

First plate 11 is seated in the opening of housing 31. A first side 11a of plate 11 faces plate 12 and a second side 11b of plate 11 faces housing member 31. Equatorial plate 12 is seated in the opening of housing 32 A first side 12a of plate 12 faces plate 11 and a second side 12b of plate 12 faces housing member 32. Plate 12 is generally flat, but in its center, the material is indented to form a slot 13a that is sized and shaped to accommodate the bottom side of a WII remote 200. Opposing plate 11 also is generally flat, but in its center a pair of substantially parallel walls extends upwardly to define a slot 13b that is sized and shaped to receive the top portion of a WII remote 200 Slot 13b of plate 11 is best seen in FIG. 4. When the two ball segments 31, 32 are fastened together, slots 13a and 13b align to form a compartment that is sized and shaped to accommodate a WII remote.

It should be noted that in an embodiment of the invention a compartment for receiving a game controller could be provided entirely in one ball segment—and not shared between the two as described above. Moreover, in an embodiment of the invention, a ball could be constructed to be solid (i.e. comprised of a single sphere and not two ball segments as described above) with a slot for receiving a game controller disposed in its cavity.

In FIG. 3, a number of rod assemblies 20 are shown. The rod assemblies begin on the outside surface of the ball 100 and terminate as contact ends 23 on the plate 11 in close proximity to buttons on WII remote 200 (when remote 200 is seated in the compartment). Each rod assembly 20 comprises an outer press button 21, a link rod 22 extending therefrom and a terminal contact end 23. When a player presses button 21, link rod 22 (extending directly from button 21) moves downward (i.e. in the direction toward plate 11 in the ball orientation shown in FIG. 3). Link rod 22 pushes contact end 23 in the same direction. Because each contact end 23 is positioned in close proximity to corresponding buttons 201 on WII remote 200, when contact end 23 is pushed by link rod 22 it moves into buttons on the WII remote 200 and thereby presses them. As such motion imparted by a user to buttons 21 is transferred by way of link rod 22 to contact end 23, which ultimately presses the buttons on the WII remote 200

Rod assemblies are provided with an outward spring bias, which allows button 21 to recover to its starting position after being released by a player. Preferably, a spring is placed around the axis of link rods 22, with the top part of the spring contacting button 21 and the bottom part of the spring contacting plate 11. As such, a constant biasing force is applied to buttons 21, which can be temporarily defied when a user imparts a counter force to buttons 21. It will be understood by those of ordinary skill in the art that buttons 21, may be provided as a pad or surface that is contiguous with housing 31, 32. The pad, when pressed by a player, similarly moves a mechanical link to press buttons on the game controller.

Rod assemblies 20 are best shown in FIG. 3, which shows the second side of plate 11b (i e the side that faces housing 31 and which is not visible to a player once plate 11 is seated in housing 31). As shown, the rod assemblies 20 extend from plate 11 to the outside of the ball—traversing the cavity defined by the hollow of semi-sphere housing 31 and then protruding through apertures 33. In FIG. 1, ball 100 is shown with both ball segments 31, 32 fastened together. Button ends 21 of rod assemblies 20 are shown protruding through apertures 33

FIG. 4 best shows the first side 11a of a plate 11 (i.e. the side that is visible to a user when the two ball segments are separated). As shown, compartment 13a is integrally formed on plate 11. The contact ends 23 of the rod assemblies 20 are shown. Contact ends are positioned to substantially align with corresponding buttons on a WII remote 200.

Two holes 50a, 50b are formed in the rear surface of housing 32. The holes accommodate two tubular members 34 —which are secured in the hollow of housing 32, for example, by way of screws or clasps. Each of the tubular members 34 has an opening on one end 52 and which is closed on a second end 53. The tubular members are positioned such their open ends 52 open into holes 50a, 50b in housing 32. The outside surfaces of tubular members 34 face the hollow cavity defined by housing 32, whereas the inside surfaces serve as pockets for receiving a player's middle and index fingers, respectively. A single hole is similarly formed in hosing 31 to receive a single tubular member 34a Single tubular member 34a similarly accommodates a player's thumb.

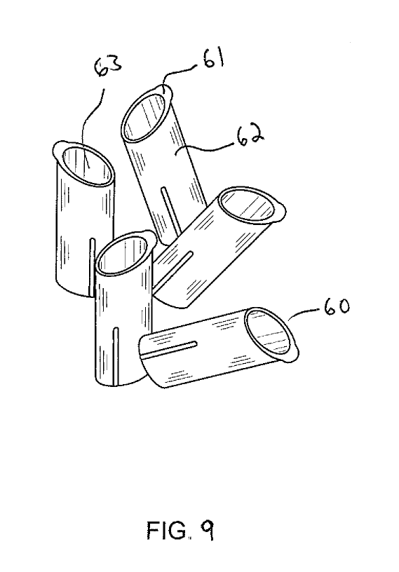

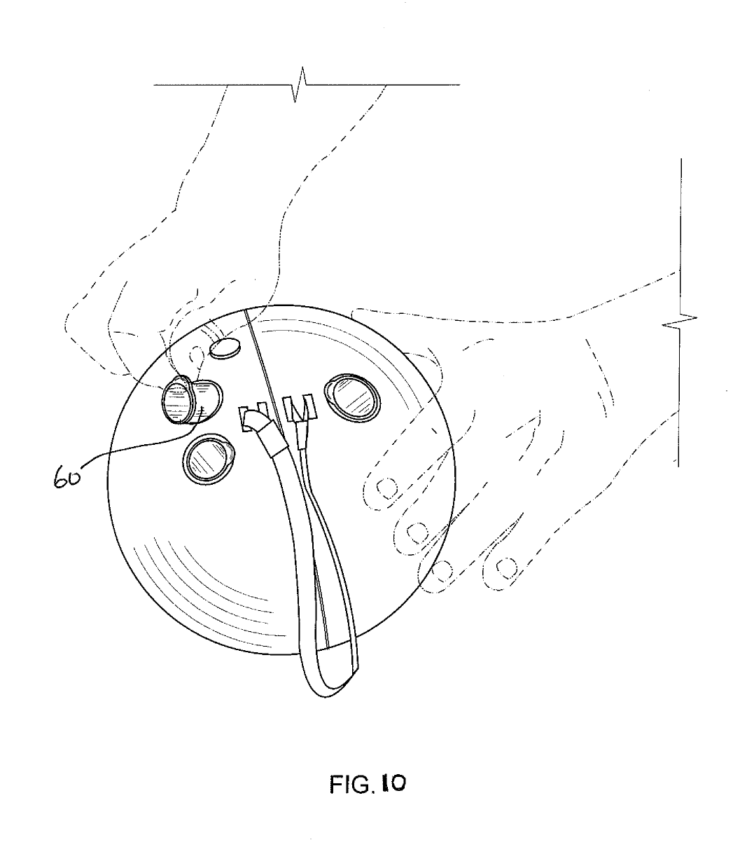

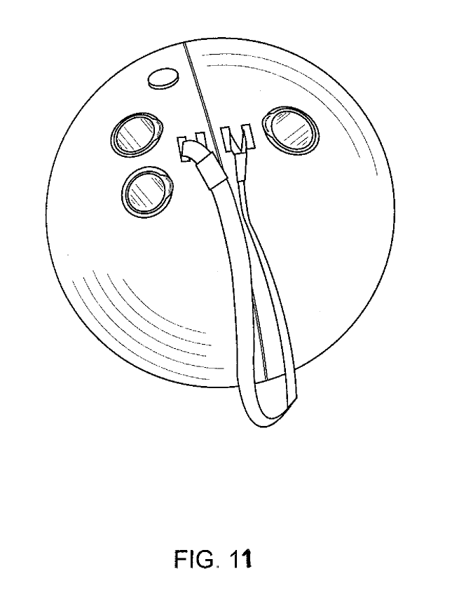

In an embodiment of the invention, and as shown in FIG. 9, in order to tailor the finger hole sizes to smaller fingers, finger hole inserts 60 are provided for inserting into the finger holes in order to diminish the size of the hole. Inserts are comprised of walls having a thickness 61. An outer surface 62 of the insert 60 is roughly sized to fit inside and make physical contact with an inside surface of the finger holes 50a, 50b. The inside surface of the inserts 63 accommodate a player's fingers. It will be understood by those of ordinary skill in the art that inserts could be manufactured in any of various material including rubber, foam and the like. The inserts also could be provided having varying degrees of thickness.

Referring to FIG. 2, a single button 21a is shown disposed in housing member 32. Button 21a is positioned in close proximity to finger hole 50b such that button 21a is easily in the reach of a player's free index finger when he/she is gripping the ball 100 in the conventional manner—that is with middle finger and ring finger respectively in finger holes 50b and 50a FIG. 6 shows a player gripping the inventive ball 100, with his/her index finger free to access button 21a. As shown, button 21a is preferably located on the housing between finger hole 50b and the edge of ball segment 32 at approximately ¾″ from finger hole 50b. In a preferred embodiment, button 21a is anywhere from about ½″ to 1″ from finger hole 50b.

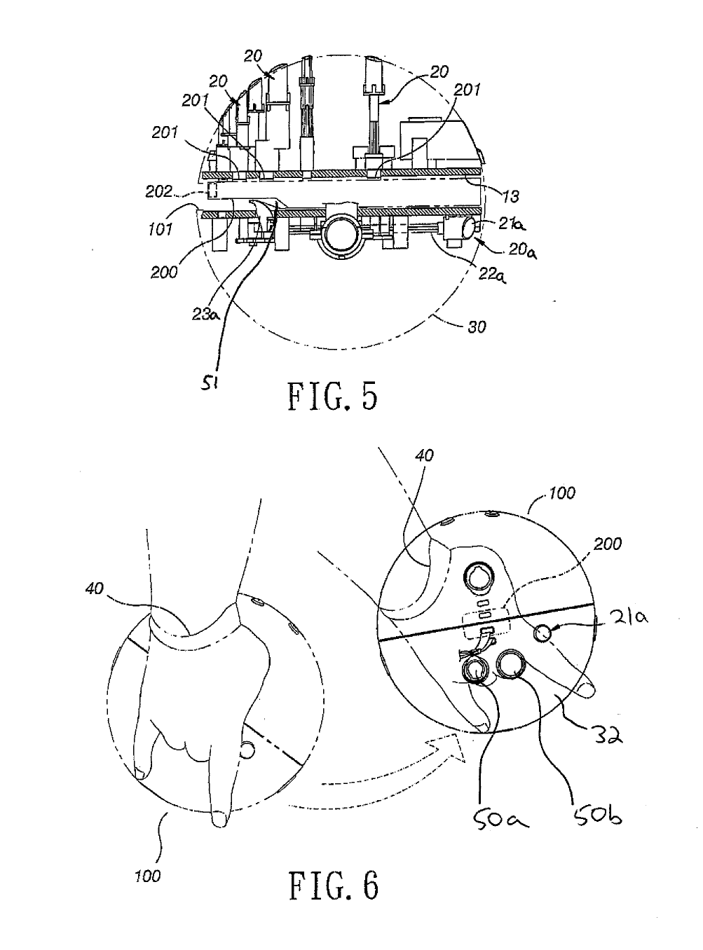

Button 21a allows a user to access a button on the underside of the WII remote. Access to such button (“B Button”) is critical, as in current versions of WII Bowling, that button allows for the “release” of the ball. To that end, and as best shown in FIG. 5, a rod assembly 20a is provided in a similar manner to that describe above. Namely, a button 21a is positioned to protrude through an aperture in housing 32 and which has a link rod 22a extending therefrom.

When a player presses button 21a, rod 22a moves laterally (i.e. when viewed according to the orientation of the ball shown in FIG. 5). However, to push the B button 51 an upward movement is necessary. In order to transfer the lateral motion imparted by link rod 22a to upward motion, a pivotable lever 23a is positioned in contact with link rod 22a. Lever 23a is connected inside of housing 32 by way of a pivot, fulcrum, hinge or the like. When lateral force is applied to bottom region thereof, the lever moves about its pivot such that the bottom region moves in the same direction of the imparted force, but the top region moves in the opposite and upward direction thereof. When lever 23a is so acted on by link rod 22a, the top of lever 23a moves into contact with button 51 on the underside of remote 200. Rod assembly 20a is similarly spring-biased as described above. It should be noted that according to this embodiment of the invention, buttons on both a top and an underside of a game controller are accessed by way of mechanical linkages to buttons on the housing.

In use, a player separates the two semi-spherical ball segments (also referred to as “housing,” “housing members” or “semi-spherical housing” herein) to expose compartment 13a. The player then inserts a WII remote into the slot 13a and fastens the two ball segments 31, 32 together—bringing plates 11 and 12 into close contact with each other. Slots 13a on plate 12 and slot 13b on plate 11 combine to form a compartment, which substantially encloses the WII remote 200. In order to securely maintain the two ball segments together as one unitary ball, plate 12 is provided with one or more snap members 14 which are snapped into corresponding catches in housing 31. In addition, release buttons 15 are provided in lateral contact with snap members 14. Housing 32 is provided with through-holes 35 which allow physical access release buttons 15. When release buttons 15 are pressed by a user, force is applied to snap members 14, thereby disengaging them and allowing for the ball 100 to be separated into two segments.

FIG. 5, shows a side, cross-sectional view of a ball 100 according to an embodiment of the invention, with a WII remote positioned therein. As shown, rod assemblies 20 extend through the hollow of housing 31 and slightly protrude therefrom. Inside the cavity of ball 100, rod assemblies terminate in close proximity to buttons 201 on WII remote 200. The WII remote 200 is shown encapsulated within the cavity of the housing and with its sensor 202 aligned and substantially parallel to opening 101

In one embodiment, opening 101 comprises a notch-out on each of the housing members, which align to for a window. In another embodiment, a complete cut-out is made to a ball segment—such as for example in the embodiment wherein a compartment is provided in entirely in one ball segment.

It will be understood by those of ordinary skill in the art that the inventive ball need not be a round ball such as a bowling ball, but that others shapes, such as that of a football may be similarly crafted according to the teachings of this disclosure.

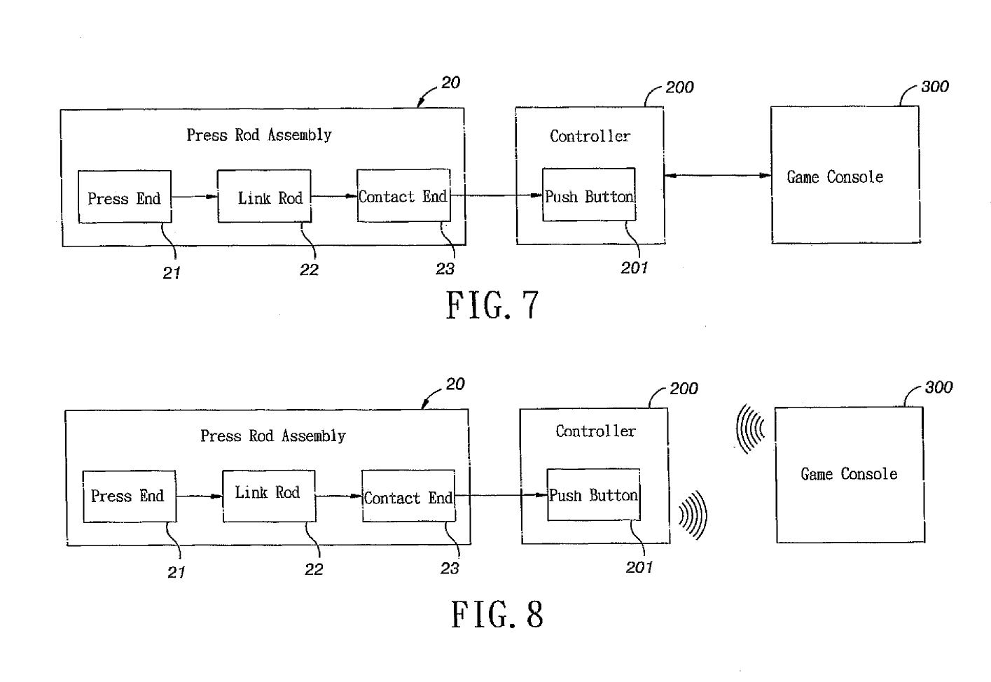

FIG. 7 shows a schematic view of an implementation of a preferred embodiment of the present invention fitted with wired control. As shown in the drawing, when the user presses down the button 21 of the rod assembly 20, the link rod 22 will be pushed to drive the contact end 23 to touch with the push button 201 of the controller 200, allowing the controller 200 to send out a wired control signal to a game console 300 through wired transmission.

FIG. 8, shows a schematic view of an implementation of a preferred embodiment of the present invention fitted with wireless control. As shown in the drawing, when the user presses down the button 21 of rod assembly 20, the link rod 22 will be pushed to drive the contact end 23 to touch with the push button 201 of the controller 200, allowing the controller 200 to send out a wireless control signals to the game console 300 through wireless transmission.

Having described this invention with regard to specific embodiments, it is to be understood that the description is not meant as a limitation since further modifications and variations may be apparent or may suggest themselves to those skilled in the art It is intended that the present application cover all such modifications and variation as fall within the scope of the appended claims

What is claimed is:

1. A housing for a game controller fix use with a video game displayed on a screen, said game controller comprising a plurality of control buttons, said control buttons controlling aspects of the display, said housing comprising:
a ball-shaped outer surface comprised of two semi-spheres and an inner cavity disposed therein;
an inner compartment for holding said game controller disposed within said inner cavity;
an opening in said ball-shaped outer surface for allowing visual access to a sensor on a game controller;
said housing comprising a plurality of control buttons linked by way of mechanical linkages to said inner compartment, said mechanical linkages being movable to press buttons on a game controller;
said housing further comprising a safety strap for tethering said housing to a person playing the game,
whereby when a person playing a video game manipulates the ball of the sport being played the ball remains in the grip of the person playing the game.

2. The housing for a game controller of claim 1, wherein the video game displayed is bowling and the housing is the shape of a bowling ball, said housing further comprising finger holes located substantially similarly to finger holes in a standard bowling ball, whereby said holes are positioned in a generally triangular configuration, whereby two holes are positioned opposite of a single hole, one of said two holes for receiving a middle finger and one of said two holes for receiving a ring finger, said single hole for receiving a thumb.

3. The housing for a game controller of claim 2, further comprising a button disposed on said outer surface in a location that is in close enough proximity to said hole for receiving a middle finger, such that said button is accessible by an index finger of a player holding said controller in a conventional manner.

4. The housing for a game controller of claim 3, whereby said button accessible by an index finger is mechanically linked to a button provided on an underside of said controller which controls the release of a ball on said display.

5. The housing for a game controller of claim 1, whereby said opening is positioned to be substantially parallel to a sensor on a game controller when said game controller is in said inner compartment.

6. The housing for a game controller of claim 6, whereby said opening comprises a notch-out made to each of said ball sections, said notch-outs combining when said ball sections are fastened together to form said opening.

7. The housing for a game controller of claim 1, whereby said game controller is encapsulated by said housing.
